(19) United States
(12) Patent Application Publication
(10) Pub. No.: US 2025/0236143 A1
(43) Pub. Date: Jul. 24, 2025

(54) SELF-LATCHING ARTICULATING RECEIVER HITCH

(71) Applicant: B & W Custom Truck Beds, Inc., Humboldt, KS (US)

(72) Inventor: Travis M. McCall, Humboldt, KS (US)

(73) Assignee: B & W Custom Truck Beds, Inc., Humboldt, KS (US)

(21) Appl. No.: 19/033,187

(22) Filed: Jan. 21, 2025

Related U.S. Application Data
(60) Provisional application No. 63/623,450, filed on Jan. 22, 2024.

(51) Int. Cl. B60D 1/02; B60D 1/173; B60D 1/52

(52) U.S. Cl. CPC B60D 1/02; B60D 1/173; B60D 1/52

(57) ABSTRACT

A hitch apparatus configured to couple a trailer to a towing vehicle and including a trailer tongue coupler removably securable to the trailer and a tongue receiver removably securable to the towing vehicle. The trailer tongue coupler is rotatable about a plurality of axes of rotation simultaneously and includes a coupling pin that is receivable by the tongue receiver. The tongue receiver includes a coupling pin receiver having a pair of mounting plates, and a pair of spring-loaded latch assemblies which are pivotably secured to the mounting plates and are selectively engageable with the coupling pin to couple the trailer tongue coupler to the tongue receiver. The spring-loaded latch assemblies are pivotable between an unlatched position and a latched position

### CROSS-REFERENCE TO RELATED APPLICATIONS

This application claims the benefit of U.S. Provisional Patent Application Ser. No. 63/623,450, entitled SELF-LATCHING ARTICULATING RECEIVER HITCH, filed Jan. 22, 2024, the disclosure of which is incorporated herein in its entirety by reference.

### FIELD OF THE INVENTION

This invention relates to apparatuses for hitching trailers to towing vehicles, and in particular to an articulated hitch apparatus that is self-latching.

### BACKGROUND

Hitching assemblies adapted to allow a towing vehicle to pull a trailer off-road over rocky or rough terrain are known and are commonly used in “overlanding” applications. Known hitch assemblies comprise multiple pivoting pins disposed in a vehicle-mounted component and/or a trailer-mounted component, with the pivoting pins enabling a broader range of movement of the trailer relative to the towing vehicle than is afforded with a conventional bumper-mounted trailer hitch. The known hitch assemblies suffer from several shortcomings, including unintentional rotation of components about their pivot pins and requiring manipulation of various parts to couple the vehicle-mounted component and trailer-mounted component, all of which often result in wasted time, lost parts, and other inefficiencies and frustrations to the user.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, an articulated hitch apparatus that self-latches for coupling a trailer to a towing vehicle.

The hitch apparatus includes an articulated trailer tongue coupler removably securable to a trailer and a trailer hitch removably securable to a towing vehicle. The trailer tongue coupler is rotatable about a plurality of axes of rotation and includes a coupling pin which is receivable by a coupling pin receiver of the trailer hitch. The coupling pin receiver includes a pair of mounting plates with slots formed therein, and a pair of self-latching assemblies that are pivotably secured to the mounting plates proximate to the slots. Each self-latching assembly is pivotable between an unlatched position and a latched position and includes a latch plate and a release plate with a spring extending therebetween. To couple the trailer tongue coupler to the trailer hitch, the self-latching assemblies are pivoted to their unlatched positions and the trailer is lowered until the coupling pin enters the slots formed in the mounting plates and presses against the latch plates, forcing the latch plates to pivot until the springs bias the self-latching assemblies to their latched positions. To decouple the trailer tongue coupler from the trailer hitch, the release plates are pivoted until the springs bias the self-latching assemblies to the unlatched positions, and the latch plates force the coupling pin upward for removal from the slots.

### DESCRIPTION OF THE DRAWINGS

Illustrative embodiments of the invention are described in detail below with reference to the attached drawing figures, and wherein:

FIG. 1 is a perspective view of a hitch apparatus in accordance with an embodiment of the invention, viewed from above and to the left and depicted with a trailer tongue coupler coupled to a trailer hitch and self-latching assemblies in latched positions;

FIG. 2 is a perspective view of the trailer hitch of the hitch apparatus of FIG. 1, viewed from above and to the right and depicted with self-latching assemblies in unlatched positions;

FIG. 3 side view of the trailer hitch of the hitch apparatus of FIG. 1, viewed from the right and depicted with self-latching assemblies in unlatched positions;

FIG. 4 is a perspective view of the trailer tongue coupler of the hitch apparatus of FIG. 1, viewed from below and to the right.

FIG. 5 is a perspective view of the trailer tongue coupler of the hitch apparatus of FIG. 1, viewed from above and to the left.

FIG. 6 is a side view of the hitch apparatus of FIG. 1, viewed from the right and depicted with the trailer tongue coupler decoupled from the trailer hitch and the self-latching assemblies in unlatched positions;

FIG. 7 is a side view of the hitch apparatus of FIG. 1, viewed from the right and depicted with the trailer tongue coupler coupled to the trailer hitch and the self-latching assemblies in latched positions;

FIG. 8 is a side section view of the hitch apparatus of FIG. 1, viewed from the right and taken along a central longitudinal axis of the hitch apparatus, and depicted with the trailer tongue coupler coupled to the trailer hitch.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

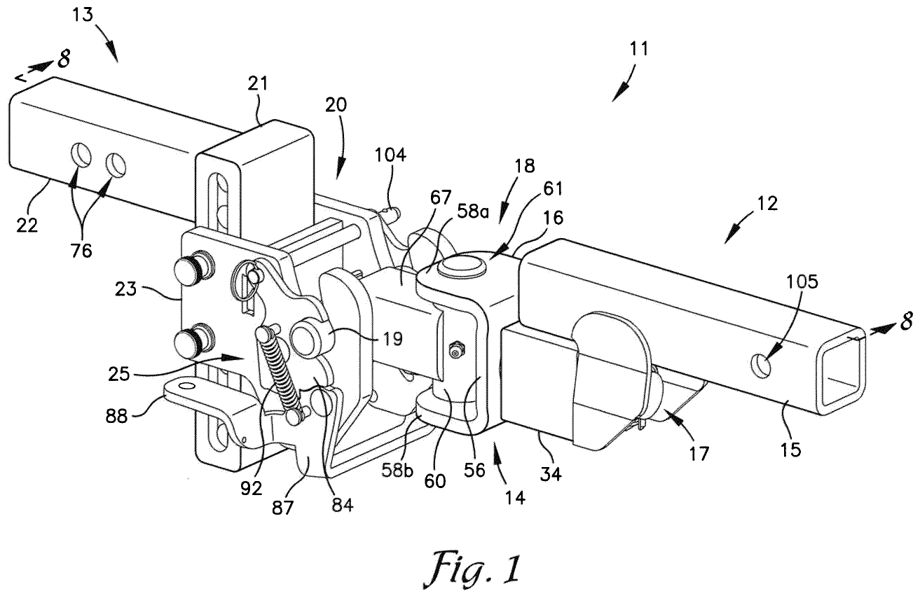

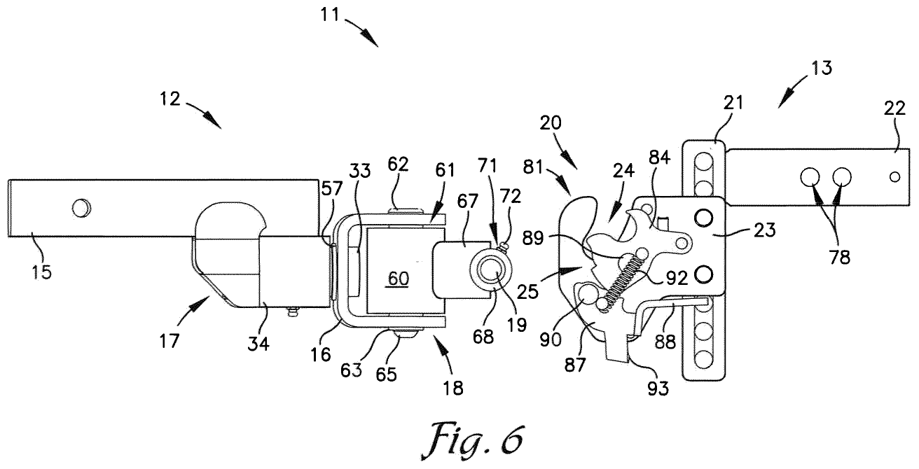

As used herein, directional references may be used with references to the orientations of the vehicle and the trailer to which the inventive hitch apparatus is configured to be secured. With reference to the orientation of the hitch apparatus shown in FIG. 1, the words the words “front” or “forward” refer to the left of the page and the words “rear” or “rearward” refer to the right of the page. Similarly, with reference to the orientation of the hitch apparatus shown in FIGS. 6-8, the words “front” or “forward” refer to the right of the page and the words “rear” or “rearward” refer to the left of the page. The words “upper” or “upwardly” refer to the top of the page and the words “lower” or “downwardly” refer to the bottom of the page. The words “inwardly” and “outwardly” will refer to directions toward and away from, respectively, the geometric center of the embodiment being described and designated parts thereof. The words “about” or “approximately” as used herein denote deviations from the exact value by +/−10%, preferably by +/−5%, and/or deviations in the form of changes that are insignificant to function. Said terminology will include the words specifically mentioned, derivatives thereof, and words of a similar import such as “above,” “below,” and the like.

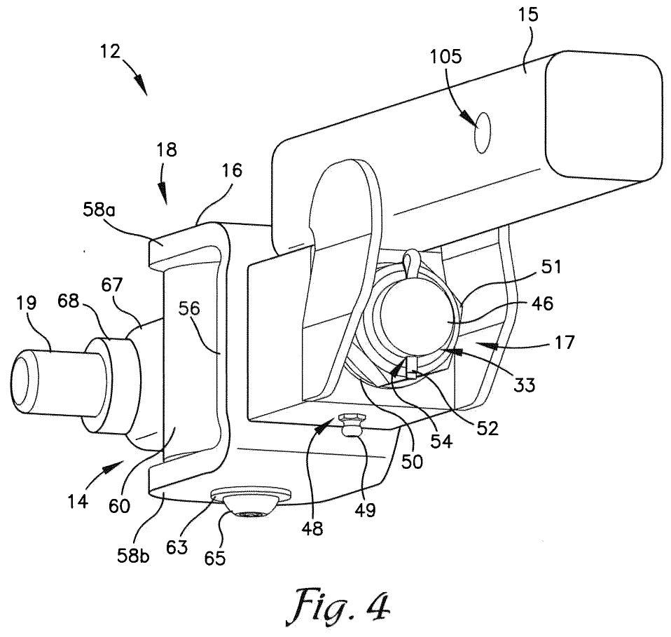

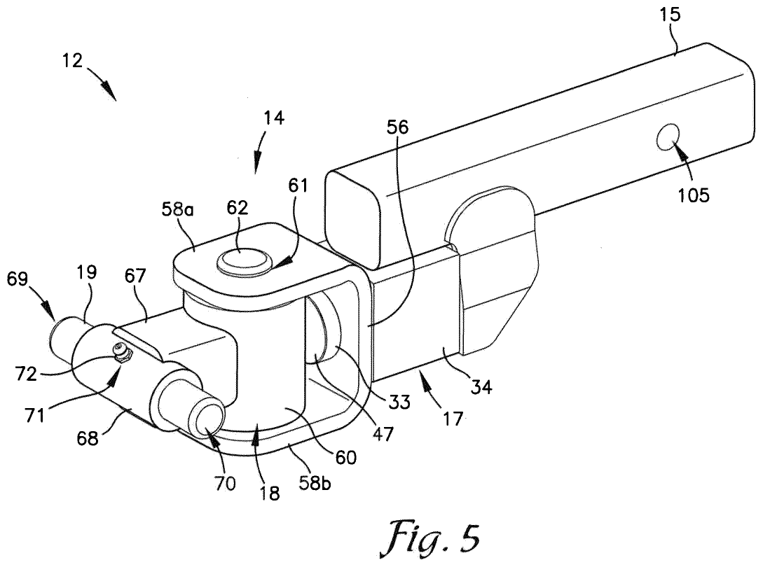

With reference to FIGS. 1-8, a hitching apparatus is described in accordance with an embodiment of the invention. The hitching apparatus 11 is particularly well-adapted for use with trailers that are pulled off-road by towing vehicles and comprises a trailer tongue coupler 12 configured for coupling with a trailer hitch or tongue receiver 13, with the trailer tongue coupler 12 removably securable to a trailer and a trailer hitch 13 removably securable to a towing vehicle. As best shown in FIGS. 4 and 5, the trailer tongue coupler 12, which may be referred to as the first coupler member 12, includes an articulating assembly 14 and a shank 15 with the articulating assembly 14 attached to a forward end of the shank 15 and the opposite or rear end of shank 15 sized and configured to be received in and secured to a receiver tube (not shown) incorporated into a trailer tongue, with the shank 15 including one or more transversely extending mounting holes 105 sized to accept removable pins (not shown) for securing the shank 15 within the trailer-mounted receiver tube.

Referring to the articulating assembly 14 in more detail, a cylindrical hitching pin or coupling pin 19 is pivotably couplable to the trailer hitch 13 and is pivotably connected to a fork or clevis 16 by a transverse pivot assembly 18, with the clevis 16 pivotably connected to the forward end of the shank 15 by a longitudinal pivot assembly 17. The clevis 16 is rotatable about a longitudinal axis extending through the longitudinal pivot assembly 17, the transverse pivot assembly 18 is rotatable about an axis extending therethrough which is transverse to the longitudinal axis of the longitudinal pivot assembly 17, and the coupling pin 19 is rotatable about an axis extending therethrough which is transverse to the axis of the transverse pivot assembly 18. The longitudinal pivot assembly 17, transverse pivot assembly 18, and coupling pin 19 cooperate to allow a trailer with the trailer tongue coupler 12 secured thereto to pivot or rotate about a plurality of axes, and in the embodiment shown, three axes relative to the trailer hitch 13 secured to the towing vehicle.

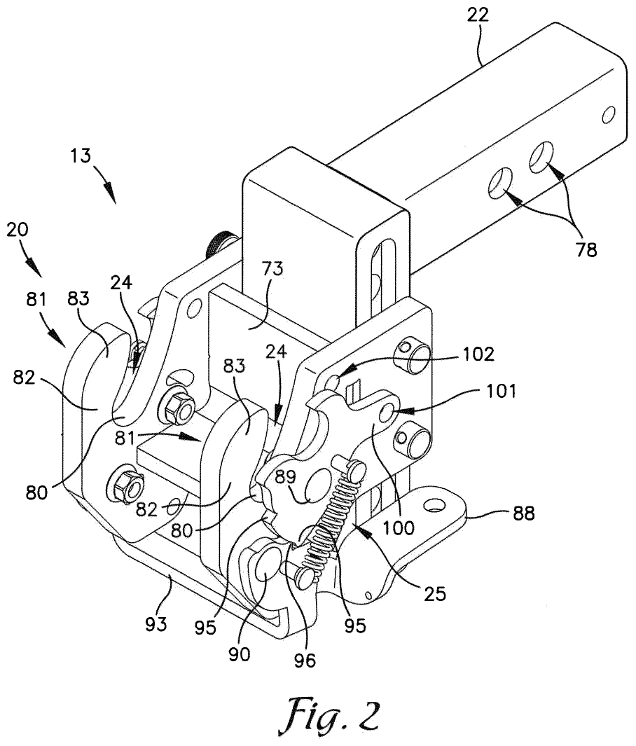

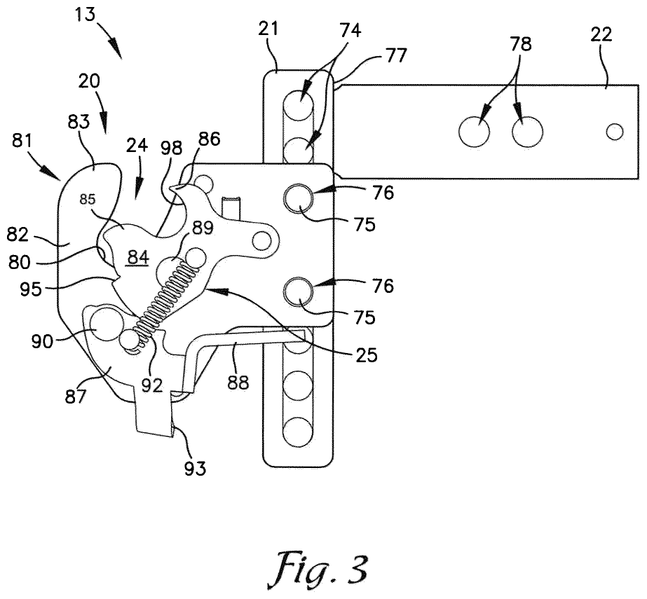

Referring to FIGS. 2 and 3, the trailer hitch 13, which may be referred to as the second coupler member 13, comprises a coupling pin receiver 20 mounted on a draw bar or drop bar 21. The draw bar 21 may be referred to as a height adjustment member 21 and is connected to a shank or shaft 22 which is removably securable within a square tube receiver of a bumper-mounted hitch receiver. In the embodiment of the trailer hitch 13 shown and described herein, the coupling pin receiver 20 is removably securable to the draw bar 21 and includes mounting plates 23 with coupling pin receiving slots 24 formed therein which project rearwardly from the draw bar 21 and are sized to receive the coupling pin 19. The coupling pin 19 is advanced into the slots 24 to couple the trailer tongue coupler 12 to the trailer hitch 13 and the coupling pin 19 is removed from the slots 24 to decouple the trailer tongue coupler 12 from the trailer hitch 13. Self-latching assemblies 25, which may be spring-loaded latches 25, are pivotably secured on each mounting plate 23 adjacent to the slot 24 formed therein. The spring-loaded latches 25 are engageable between an unlatched position and a latched position, with the latches 25 in the latched position allowing rotation of the coupling pin 19 within the slots 24.

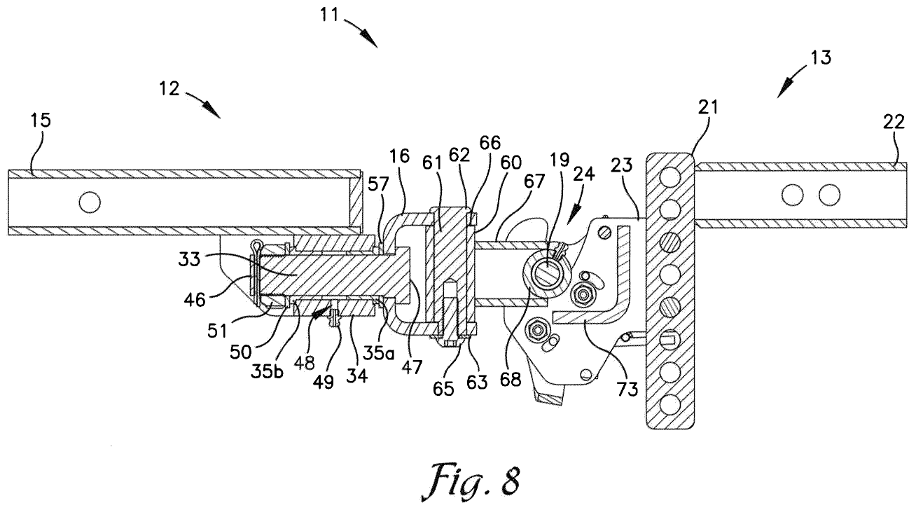

Referring to FIGS. 4, 5 and 8, the longitudinal pivot assembly 17 includes a substantially cylindrical pivot pin 33 which may be referred to as a longitudinal pivot pin or a first pivot pin 33 and is configured to rotate about an axis extending through the longitudinal pivot assembly 17 such that the trailer to which the trailer tongue coupler 12 is secured is rotatable for side-to-side motion relative to the trailer hitch 13 secured to the towing vehicle. The pivot pin 33 extends through a bearing block 34 with a pair of flanged longitudinal bushings 35a and 35b surrounding the pivot pin 33 and extending between the pivot pin 33 and the bearing block 34. The pivot pin 33 extends from a rear end 46 disposed rearward of the bearing block 34 and beneath the shank 15 to a forward end 47 having a radial flange formed thereon. The flanged longitudinal bushings 35a and 35b may be referred to as forward and rearward longitudinal bushing 35a and 35b and, as shown in FIG. 8, circumscribe respective portions of the pivot pin 33, with the forward longitudinal bushing 35a oriented proximate to the forward end 47 of the pivot pin 33 and the rearward longitudinal bushing 35b oriented proximate to the rear end 46 of the pivot pin 33. It is foreseen that the longitudinal bushings 35a and 35b may be a single bushing, and it is further foreseen that the longitudinal bushings 35a and 35b may comprise bearings such as sleeve bearings. A grease port 48 is formed in a face of the bearing block 34 for receiving a zerk 49 through which lubricant, such as oil or grease, is applied to the pivot pin 33 to facilitate rotational movement between the pivot pin 33, the bearing block 34, and/or longitudinal bushings 35a and 35b.

The longitudinal pivot assembly 17 includes securement means for fixing the position of the longitudinal pivot pin 33 relative to the bearing block 34 and the longitudinal bushings 35a, 35b. As best shown in FIG. 4, the securement means may include a rear washer 50 and a nut 51 attached to the longitudinal pivot pin 33 proximate the rear end 46 thereof. In the embodiment shown, the rear washer 50 is situated between the nut 51 and the flange of the rearward longitudinal bushing 35b. The securement means may further include a split cotter pin 52 inserted through a cotter pin receiving hole 54 formed in the rear end 46 of the longitudinal pivot pin 33, the cotter pin 52 retaining the rear washer 50 and the nut 51 on the rear end 46 of the pivot pin 33.

Referring now to FIGS. 5-7, the forward end 47 of the longitudinal pivot pin 33 extends through a base 56 of the fork or clevis 16. In the embodiment shown, the clevis base 56 is rotatably supported or held against the bearing block 34 by the radial flange projecting outward from the forward end 47 of the longitudinal pivot pin 33. A forward washer 57 is positioned between the clevis base 56 and the flange of the forward longitudinal bushing 35b to facilitate rotation of the clevis 16 relative to the bearing block 34. The clevis 16 includes a pair of tabs or prongs 58a and 58b which extend forward from opposite ends of the clevis base 56, with the transverse pivot assembly 18 extending therebetween.

The transverse pivot assembly 18 includes an annular pivot pin housing or sleeve 60 which circumscribes and is rotatable about a transverse pivot pin 61 connected to and extending between the prongs 58a and 58b of the clevis 16. The transverse pivot pin 61, which may be referred to as the transverse pivot axle 61, is substantially cylindrical and extends through the annular pivot pin housing 60 from an upper end 62 to a lower end 63, with the transverse pivot pin 61 and the pivot pin housing 60 extending along the same axis, which extends transverse to the axis extending through the longitudinal pivot pin 33 and may be referred to as a first transverse axis. The transverse pivot pin 61 and the pivot pin housing 60 extend along the same axis and can thus be said to be coaxially aligned. The transverse pivot pin 61 includes an enlarged head formed on the upper end 62 thereof for positioning against prong 58a of the clevis 16. The transverse pivot pin 61 is shown secured in place by a washer positioned against prong 58b and held in place by a screw 65 screwed into the lower end 63 of the transverse pivot pin 61.

In an embodiment of the articulating assembly 14, one or more bearing sleeves or annular bushings 66 (see FIG. 8) are positioned between the transverse pivot pin 61 and the annular pivot pin housing 60 to cushion the rotational and torsional forces acting on the annular pivot pin housing 60 as it rotates relative to the transverse pivot pin 61 and about a transverse axis extending therethrough to allow the trailer to which the trailer tongue coupler 12 is secured to pivot laterally relative to the trailer hitch 13 secured to the towing vehicle. The annular bushing or bearing 66 is positioned between the transverse pivot pin 61 and the annular pin housing 60 concentric and coaxial therewith, and it is foreseen that the annular bushing 66 may be formed of urethane, polyethylene, or other plastic or composite materials. A grease port (not shown) configured to receive a zerk (not shown) may be incorporated into the transverse pivot pin 61, the annular pivot pin housing 60, and/or the annular bushing 66 to enable application of a lubricant to facilitate rotational motion thereof. It is foreseen that the annular bushing 66 may be formed as a plurality of cylindrical bushings.

The coupling pin 19 is connected to the transverse pivot assembly 18 by a support arm 67 extending therebetween. The support arm 67 extends laterally outward from the pivot pin housing 60, with one end of the support arm 67 connected to the pivot pin housing 60 and a generally annular coupling pin bearing sleeve 68 connected to the opposite end of the support arm 67. The coupling pin bearing sleeve 68 is oriented such that an axis extending longitudinally therethrough extends transverse to both the axis extending through the longitudinal pivot pin 33 and the axis extending through the transverse pivot pin 61. The coupling pin bearing sleeve 68 is sized and configured to receive and rotatably support the coupling pin 19, which is generally cylindrical and extends longitudinally from a first end 69 to a second end 70 along the same axis as the coupling pin bearing sleeve 68, which may be referred to as the second transverse axis. The coupling pin 19 and the coupling pin bearing sleeve 68 may therefore be said to be coaxially aligned. When secured in the slots 24 of the coupling pin receiver 20, the coupling pin 19 is held in a generally horizontal orientation transverse to the direction of travel of the towing vehicle to which the trailer hitch 13 is secured, and the bearing sleeve 68 is rotatable relative to the coupling pin 19 and about its longitudinal axis to allow the trailer to which the trailer tongue coupler 12 is secured to pivot vertically relative to the towing vehicle and the trailer hitch 13 secured thereto. A grease port 71 is formed in the coupling pin bearing sleeve 68 for receiving a zerk 72 through which lubricant, such as oil or grease, is applied between the coupling pin 19 and the bearing sleeve 68 to facilitate rotational movement between the coupling pin 19 and the coupling pin bearing sleeve 68.

The first and second ends 69 and 70 of the coupling pin 19 form and may be referred to as first and second cylindrical projections or trunnions 69 and 70 which are sized and positioned to be received in the slots 24 of the mounting plates 23 of the trailer hitch 13. The mounting plates 23 are horizontally spaced apart from each other a distance corresponding the length of the coupling pin 19, such that when the trailer tongue coupler 12 is coupled with the trailer hitch 13 the first trunnion 69 of the coupling pin 19 is received within the slot 24 of one mounting plate 23 and the second trunnion 70 of the coupling pin 19 received within the slot 24 of the other mounting plate 23, with the coupling bearing sleeve 68 extending between the mounting plates 23. As best shown in FIG. 2, in an embodiment of the trailer hitch 13, the mounting plates 23 are interconnected and spaced apart by a spacing plate or bridge piece 73 which extends therebetween. The bridge piece 73 is L-shaped and welded to or otherwise fixedly secured to the mounting plates 23 in the embodiment of the trailer hitch 13 shown. In the embodiment of the trailer hitch 13 shown and described herein, the mounting plates 23 are spaced apart slightly wider than the width of the draw bar 21 and the draw bar 21 is of the type having a plurality of pin receiving bores 74 formed therein in vertically spaced alignment for receiving one or more securement pins 75 for connecting the coupling pin receiver 20 to the draw bar 21. Pin receiving holes 76 which are formed in the mounting plates 23 of the coupling pin receiver 20 are selectively alignable with the pin receiving bores 74 of the draw bar 21, and the securement pins 75 are inserted through the aligned bores 74 and pin receiving holes 76 to secure the coupling pin receiver 20 to the draw bar 21. The vertical position of the coupling pin receiver 20 is adjustable relative to the draw bar 21 by aligning the pin receiving holes 76 with different sets of pin receiving bores 74. The draw bar 21 includes a forward face 77 to which the shank 22 is welded or otherwise connected, the shank 22 being configured for removable securement within a receiver tube mounted to the towing vehicle. The shank 22 is sized such that when the tongue receiver 13 is secured to the towing vehicle, a substantial portion of the shank 22 is received within the vehicle-mounted receiver tube, and one or more transversely extending mounting holes 78 formed in the shank 22 are aligned with corresponding transversely extending mounting holes formed in the vehicle-mounted receiver tube such that removable pins (not shown) may be inserted through the aligned mounting holes to secure the tongue receiver 13 to the towing vehicle.

Referring to FIGS. 1-3, each slot 24 extends downward into a respective mounting plate 23 from an upper edge thereof before curving rearwardly to define an end wall 80 having a curvature corresponding to the circumference of the coupling pin 19, with the coupling pin 19 configured to abut against the end walls 80 when the trailer tongue coupler 12 is coupled to the trailer hitch 13. The slots 24 define hooks 81 formed at rear sections of the mounting plates 23, with each hook 81 including a stem 82 and a lobe 83. When the trailer tongue coupler 12 is coupled with the trailer hitch 13 as shown in FIG. 1, the lobes 83 extend above portions of the first and second trunnions 69 and 70 to resist advancement of the coupling pin 19 out of the slots 24 and the stems 82 bear the load of the trailer to which the trailer tongue coupler 12 is secured as it is towed by the towing vehicle.

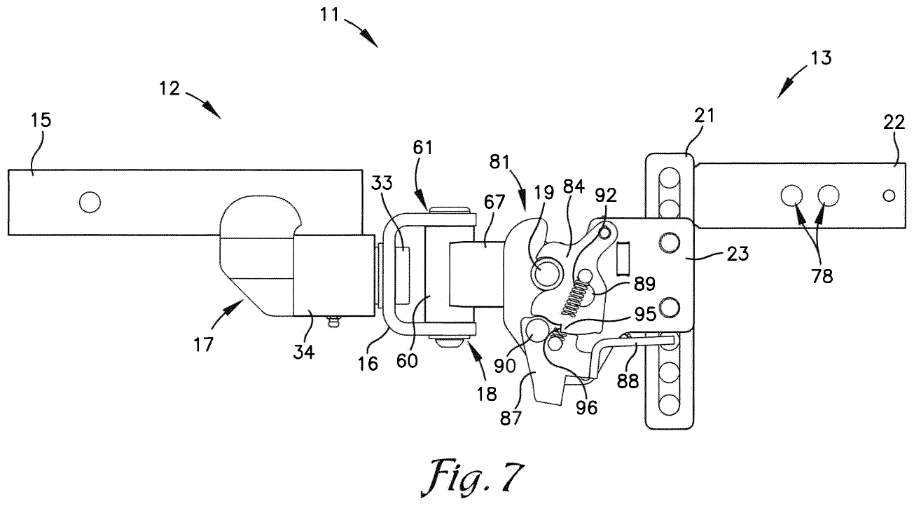

A spring-loaded latch 25 is pivotably secured to an outer surface of each mounting plate 23 proximate to the slot 24 formed therein, with each spring-loaded latch 25 comprising a first plate or latch plate 84 which includes a curved tongue 85 and a curved lip 86, and a second plate or release plate 87 which includes a release lever 88. Each latch plate 84 is pivotably mounted to its respective mounting plate 23 by a latch plate pivot connection 89 located slightly forward of the lower end of the slot 24 of the mounting plate 23, and each release plate 87 is pivotably mounted to its respective mounting plate 23 by a release plate pivot connection 90 located below the lower end of the slot 24. The spring-loaded latches 25 are pivotable between an unlatched position (see FIGS. 3 and 6) wherein the latch plates 84 are pivoted forward such that their curved tongues 85 are situated above the end walls 80 and their curved lips 86 are situated substantially forward of the slots 24, and a latched position (see FIG. 7) wherein the latch plates 84 are pivoted rearward such that their curved tongues 85 are situated just below the end walls 80 and their curved lips 86 extend across the slots 24 and are situated above the end walls 80. Each spring-loaded latch 25 includes an extension spring 92 which extends between the latch plate 84 and the release plate 87 and achieves an over-center condition relative to the latch plate pivot connection 89 to bias the spring-loaded latches 25 to their unlatched positions when the extension springs 92 extend below the latch plate pivot connections 89 and to bias the spring-loaded latches 25 to their latched positions when the extension springs 92 extend above the latch plate pivot connections 89. In an embodiment of the trailer hitch 13, the release plates 87 of the spring-loaded latches 25 are connected by a bar 93 which extends beneath the mounting plates 23 and mechanically interlinks the spring-loaded latches 25 such that they pivot between the unlatched position and the latched position in tandem.

To couple the trailer tongue coupler 12 with the trailer hitch 13, the spring-loaded latches 25 are pivoted to their unlatched positions and the coupling pin 19 is lowered into the slots 24 of the mounting plates 23 such that the first and second trunnions 69 and 70 contact the curved tongues 85 of corresponding latch plates 84. The force of the trunnions 69 and 70 advancing downward on the curved tongues 85 pivots the latch plates 84 rearward against the force of the springs 92 until shoulders 95 projecting downward from lower edges of the latch plates 84 pivot past upwardly projecting catches 96 formed on the release plates 87 and the curved lips 86 of the latch plates 84 pivot over the respective first and second trunnions 69 and 70 such that the trunnions 69, 70 are received by pin receiving grooves 98 formed in the latch plates 84 between the curved tongues 85 and the curved lips 86. When the latch plates 84 are pivoted such that the extension springs 92 extend above the latch plate pivot connections 89, the extension springs 92 draw the release plates 87 upward until the spring-loaded latches 25 are pivoted to their latched positions with the shoulders 95 of the latch plates 84 engaging the catches 96 of the release plates 87. Along with the force of the springs 92, the engagement of the shoulders 95 and the catches 96 prevents the spring-loaded latches 25 from pivoting out of their latched positions. Because the springs 92 force the spring-loaded latches 25 to automatically latch on to the trunnions 69 and 70 when the coupling pin 19 is lowered into the slots 24, the hitch apparatus 11 can be considered “self-latching.”

As best shown in FIGS. 1 and 2, the latch plates 84 include protrusions 100 having lock pin holes 101 formed therein which are alignable with lock pin holes 102 which are formed in the mounting plates 23 between the slots 24 and the pin receiving holes 76. When the spring-loaded latches 25 are in their latched positions, the lock pin holes 101 are coaxially aligned with the lock pin holes 102 such that a removable lock pin 104 (see FIG. 1) may be extended through each pair of aligned holes 101 and 102 to fix the orientation of the latch plates 84 and retain the spring-loaded latches 25 in their latched positions. It is understood that the removable lock pin 104 may be held in place by a cotter pin, clevis pin, or the like (not shown), and it is further understood that the removable pin may comprise lock means (not shown) such as a sleeved receiver lock.

To decouple the trailer tongue coupler 12 from the trailer hitch 13, the release levers 88 are forced downward to pivot the release plates 87 downward, thereby advancing the catches 96 below the shoulders 95 of the latch plates 84 and the springs 92 below the latch plate pivot connections 89 such that the springs 92 bias the spring-loaded latches 25 to their unlatched positions. The latch plates 84 are pivoted forward with the curved lips 86 advancing forwardly away from the slots 24 and the curved tongues 85 advancing upwardly to push the first and second trunnions 69 and 70 of the coupling pin 19 away from the end walls 80 and into their respective slots 24. With the spring-loaded latches 25 in their unlatched positions, the trunnions 69 and 70 are freely removable from the slots 24 as the trailer to which the trailer tongue coupler 12 is secured is raised and the coupling pin 19 advances upwardly.

Operation of the hitch apparatus 11 is now described in accordance with an embodiment of the invention. The shank 15 of the trailer tongue coupler 12 is advanced into the receiver tube incorporated on the tongue of the trailer to secure the trailer tongue coupler 12 to the trailer, and the shank 22 of the tongue receiver 13 is advanced into the receiver tube mounted on the bumper of the towing vehicle to secure the tongue receiver 13 to the towing vehicle. The coupling pin receiver 20 of the tongue receiver 13 is vertically positioned on the draw bar 21, and the trailer is raised or lowered until the coupling pin 19 of the trailer tongue coupler 12 extends in a plane above the upper edges of the mounting plates 23 of the coupling pin receiver 20. The towing vehicle is operably adjusted to position the tongue receiver 13 such that each of the first and second trunnions 69 and 70 of the coupling pin 19 are situated above a corresponding slot 24 and the coupling pin bearing sleeve 68 is situated above the space between the mounting plates 23. It should be understood that vertical positioning of the coupling pin receiver 20 and/or raising and lowering of the trailer may occur before or after operable adjustment of the towing vehicle to position the tongue receiver 13 relative to the trailer tongue coupler 12.

With the spring-loaded latches 25 in their unlatched positions, the trailer is lowered until the first and second trunnions 69 and 70 enter the slots 24 and contact the curved tongues 85 of the latch plates 84. As the trailer is further lowered, the trunnions 69 and 70 press against the curved tongues 85 of the latch plates 84 and force the latch plates 84 to pivot rearward until the springs 92 bias the spring-loaded latches 25 to pivot to their latched positions such that the curved lips 86 of the latch plates 84 extend over the trunnions 69 and 70 and the trunnions 69 and 70 are held against the end walls 80 of the slots 24 by the latch plates 84 and received by the pin receiving grooves 98 thereof. The lock pin 104 is extended through the aligned lock pin holes 101, 102 to retain the spring-loaded latches 25 in the latched positions during transit.

With the trailer tongue coupler 12 thereby coupled with the tongue receiver 13, the towing vehicle is operated to pull the trailer and cargo stored thereon from one location to another location. The articulating assembly 14 of the trailer tongue coupler 12 enables pivoting of the trailer about a plurality of axes relative to the tongue receiver 13 during transit, including rotation of the longitudinal pivot assembly 17 to allow side-to-side motion of the trailer relative to the tongue receiver 13, rotation of the transverse pivot assembly 18 to allow lateral pivoting of the trailer relative to the tongue receiver 13, and rotation of the bearing sleeve 68 relative to the coupling pin 19 to allow vertical pivoting of the trailer relative to the tongue receiver 13. The trailer may simultaneously pivot around one or more of the axes of rotation defined by the articulating assembly 14 during transit, with such simultaneous pivoting particularly common when the towing vehicle pulls the trailer across the rugged terrain commonly encountered when pulling overlanding trailers.

Upon reaching a destination, the towing vehicle is stopped and the lock pin 104 is removed from the aligned lock pin holes 101 and 102. The release levers 88 are pressed downward, forcing the release plates 87 to pivot downward until the springs 92 bias the spring-loaded latches 25 to their unlatched positions. So positioned, the curved lips 86 of the latch plates 84 are pulled away from the trunnions 69 and 70, and the curved tongues 85 of the latch plates 84 push the trunnions 69 and 70 off of the end walls 80 and upwardly into the slots 24. The trailer is raised until the trunnions 69 and 70 depart from the slots 24 and the coupling pin 19 extends in a plane above the upper edges of the mounting plates 23, thereby decoupling the trailer tongue coupler 12 from the tongue receiver 13. The towing vehicle is then moved away from the trailer, and the trailer is lowered or otherwise adjusted to a stabilized position.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of this disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device assembly including one or more of the elements at issue. Similarly, references to first and second elements, or to a pair of elements, is not intended to limit the claims to such assemblies including only two of the elements, but rather is intended to cover two or more of the elements at issue. Only where limiting language such as “a single” or “only one” is used with reference to an element, is the language intended to be limited to one of the elements specified, or any other similarly limited number of elements.

What is claimed is:

1. A hitch apparatus for coupling a trailer to a towing vehicle, the hitch apparatus comprising:
a first coupler member removably securable to the trailer, the first coupler member rotatable about a plurality of axes of rotation and having a coupling pin; and
a second coupler member removably securable to the towing vehicle, the second coupler member comprising a coupling pin receiver with a pair of spring-loaded latch assemblies pivotably secured to the coupling pin receiver; wherein:
the coupling pin of the first coupler member is receivable by the second coupler member; and
each of the pair of spring-loaded latch assemblies is pivotable between a latched position and an unlatched position.

2. The hitch apparatus as in claim 1, wherein the coupling pin receiver of the second coupler member includes a pair of mounting plates each having a slot formed therein for receiving the coupling pin, and each of the pair of spring-loaded latch assemblies is pivotably secured to an outer surface of a corresponding one of the pair of mounting plates.

3. The hitch apparatus as in claim 2, wherein each of the pair of mounting plates includes a hook defined by the slot formed therein, the hooks configured to retain the coupling pin in the slots.

4. The hitch apparatus as in claim 1, wherein the plurality of axes of rotation about which the first coupler member rotates comprises a longitudinal axis of rotation extending through a longitudinal pivot pin, a first transverse axis of rotation extending through a transverse pivot pin, and a second transverse axis of rotation extending through the coupling pin.

5. The hitch apparatus as in claim 4, wherein one or more annular bearings support the longitudinal pivot pin and one or more annular bearings support the transverse pivot pin.

6. A hitch apparatus for coupling a trailer to a towing vehicle, the hitch apparatus comprising:
an articulated trailer tongue coupler removably securable to the trailer, the articulated trailer tongue coupler comprising a longitudinally extending first pivot pin, a transversely extending second pivot pin, and a coupling pin; and
a tongue receiver removably securable to the towing vehicle and including a pair of mounting plates, each of the pair of mounting plates having a self-latching assembly pivotably secured thereto, the coupling pin and the self-latching assemblies cooperable to couple the articulated trailer tongue coupler to the tongue receiver.

7. The hitch apparatus as in claim 6, wherein each self-latching assembly includes a latch plate, a release plate, and a spring, each latch plate having a tongue and a lip with a groove extending therebetween, the grooves configured to receive respective portions of the coupling pin.

8. The hitch apparatus as in claim 7, wherein engagement of the coupling pin with the tongues of the latch plates positions the springs to bias the self-latching assemblies to latched positions wherein the lips of the latch plates extend over the coupling pin.

9. The hitch apparatus as in claim 6, wherein the coupling pin is a single cylinder having first and second trunnions, the first trunnion engageable with a first one of the self-latching assemblies and the second trunnion engageable with a second one of the self-latching assemblies.

10. The hitch apparatus as in claim 9, wherein the coupling pin extends through a receiver that projects outward from a support arm extending forward from the second pivot pin, the first and second trunnions projecting outward from opposite ends of the receiver.

11. The hitch apparatus as in claim 9, wherein a slot is formed in each of the pair of mounting plates, the first trunnion receivable in the slot formed in a first one of the mounting plates and the second trunnion receivable in the slot formed in a second one of the mounting plates.

12. A hitch apparatus for coupling a trailer to a towing vehicle, the hitch apparatus comprising:
a trailer hitch removably securable to the towing vehicle and including a coupling pin receiver and two self-latching assemblies; and
an articulated member removably securable to the trailer and including a coupling pin receivable by the coupling pin receiver and engageable with the self-latching assemblies to couple the articulated member to the trailer hitch; wherein:
the articulated member defines three axes of rotation about which the trailer is pivotable relative to the trailer hitch.

13. The hitch apparatus as in claim 12, wherein the coupling pin receiver includes two mounting plates, each mounting plate having a slot formed therein which defines an end wall which a portion of the coupling pin abuts against when the articulated member is coupled to the trailer hitch.

14. The hitch apparatus as in claim 13, wherein the trailer hitch includes a draw bar to which the mounting plates are mounted, each of the mounting plates and the draw bar having corresponding mounting features allowing vertical adjustment of the coupling pin receiver relative to the draw bar.

15. The hitch apparatus as in claim 14, wherein the mounting plates are spaced apart from each other a distance slightly wider than the width of the draw bar.

16. The hitch apparatus as in claim 12, wherein the three axes of rotation comprise a first axis extending through a first pivot pin, a second axis extending through a second pivot pin, and a third axis extending through the coupling pin, the first axis extending longitudinally relative to the articulated member, the second axis extending transverse to the first axis, and the third axis extending transverse to the first axis and transverse to the second axis.

17. The hitch apparatus as in claim 16, wherein rotation of the first pivot pin is supported by a first bearing and rotation of the second pivot pin is supported by a second bearing.

18. The hitch apparatus as in claim 13, wherein each of the self-latching assemblies is pivotably secured to a corresponding mounting plate proximate to the slot formed therein, and each of the self-latching assemblies is pivotable between an unlatched position and a latched position.

19. The hitch apparatus as in claim 18, wherein each of the self-latching assemblies includes a first plate and a second plate with a spring extending therebetween, each first plate secured to the corresponding mounting plate by a first pivot connection and each second plate secured to the corresponding mounting plate by a second pivot connection, the first plates having grooves for receiving portions of the coupling pin when the articulated member is coupled to the trailer hitch.

20. The hitch apparatus as in claim 19, wherein each of the springs extends below a corresponding one of the first pivot connections when the self-latching assemblies are in the unlatched positions and each of the springs extends above a corresponding one of the first pivot connections when the self-latching assemblies are in the latched positions.
